(19) United States
(12) Patent Application Publication
(10) Pub. No.: US 2005/0206108 A1
(43) Pub. Date: Sep. 22, 2005

(54) Walk-assisting cart

(76) Inventor: Charles Chung, Taipei Hsien (TW)

Correspondence Address: Charles Chung, 235 Chung-Ho, Box 8-24, Taipei, TW

(21) Appl. No.: 10/801,920

(22) Filed: Mar. 17, 2004

(51) Int. Cl. B62M 1/00

(52) U.S. Cl. 280/87.1; 135/67; 280/87.041

(57) ABSTRACT

A walk-assisting cart for assisting walking for fat, old or handicapped people comprises a main frame pivotally connected with a rear wheel. A seat post with a seat and a handle frame are extended uprightly from the main frame. A brace is mounted at the front end of the main frame provided with a turntable, a wheel holder and a front wheel. The wheel holder is obliquely extended from the turntable, so that the front wheel situates off the axis of said turntable. Therefore, the wheel holder tends to tilt toward the rear end of the main frame when weighed upon. The above features enable stable straight motion of the walk-assisting cart, achieving the purposes of convenience and safety for a rider.

### FIELD OF THE INVENTION

The present invention relates to walk-assisting carts, and more particularly to a walk-assisting cart that serves as an assisting or training device for old, fat or handicapped persons who cannot walk normally. Different from the powered carts of the prior art having three or four wheels, ordinary foot stepping as well as the body weight of the sitter drive the present invention. The wheel holder of the front wheel is tilted toward the rear wheel of the cart, so that the front wheel tends to align in the forward direction, and therefore work is needed to turn the front wheel.

### DESCRIPTION OF THE PRIOR ART

The conventional three-wheeled or four-wheeled carts for assisting people who cannot walk properly are generally electrically powered. A rider sitting on the cart uses a handle to control the moving direction. However, walk-assisting carts of the prior art are heavy and of large size and therefore susceptible to power shortage or bad road condition. On the other hand, people who are fat, old or lightly handicapped do not lose the capability of walking completely. The walk-assisting devices used by there people can be a walking stick or a walking rack, which do not completely support the weight of a user and therefore cannot alleviate the stress in the joints. Therefore, those people who use them to assist walking cannot go far.

### SUMMARY OF THE INVENTION

Accordingly, the primary objective of the present invention is to provide a walk-assisting cart wherein a rider sits on a seat of properly adjusted height and has his total body weight supported by the cart to alleviate the stress on his legs. The rider's foot stepping drives the cart, so the cart can train walking capability of a fat, old or lightly handicapped person who uses it. And, because of complete support of a rider's weight, the rider can walk for a long distance. Further, since the cart is easily balanced by two feet straddled on two sides of the cart, a rider can stop anytime for a rest. The walk-assisting cart of the present invention can provide pleasure of walking for a fat, old or lightly handicapped person.

The secondary objective of the present invention is to provide a walk-assisting cart that maintains a steady straight motion. The front wheel of the cart under a brace situates off the axis of the brace. The axis of the brace therefore is tilted toward the main axis of the cart. As the rider rides the cart forward on a flat ground, the frictional force and stress produced during the rolling of the front wheel on the ground urge the front wheel and situate it in a position in which the front wheel is bent toward the rear portion of the cart. Since the front wheel supports the weight of the rider, the wheel holder retaining the front wheel therefore cannot erect upward freely and the front wheel cannot change direction easily. More specifically, due to this stable configuration of the front wheel, any change in direction requires an upward motion of the wheel holder, and therefore a rotational torque is needed to overcome the downward pressure on the front wheel due to the weight of the rider and the cart itself. Therefore, the front wheel and the main axis of the cart maintain an equilibrium configuration by which the cart can go straight naturally.

The third objective of the present invention is to provide a walk-assisting cart that can turn to another direction by firstly stepping the foot of the rider corresponding to the direction turning to outward, thereby the cart tilting toward the direction. Since the front wheel is off the axis of the brace, it acquires a torque opposite to the turning direction for moving the front wheel off the equilibrium position and thereby moving upward; this upward force provides a centripetal component necessary for a turning motion. As the cart moves straight again, the front wheel is again pressed downward, and the frictional force and stress guide the front wheel back to the equilibrium point.

The various objects and advantages of the present invention will be more readily understood from the following detailed description when read in conjunction with the appended drawings.

### BRIEF DESCRIPTION OF THE DRAWINGS

FIG. 1 is a perspective view of the first preferred embodiment of the present invention.

FIG. 2 is a lateral view of the first preferred embodiment of the present invention.

FIG. 3 illustrates the principle of the present invention maintaining straight movement.

FIG. 4 illustrates the present invention assisting a rider walking forward.

FIG. 5 illustrates the turning of the present invention.

FIG. 6 illustrates a rider riding the present invention.

FIG. 7 is a lateral view of the second preferred embodiment of the present invention.

FIG. 8 is a perspective view of the third preferred embodiment of the present invention.

### DETAILED DESCRIPTION OF THE PREFERRED EMBODIMENTS

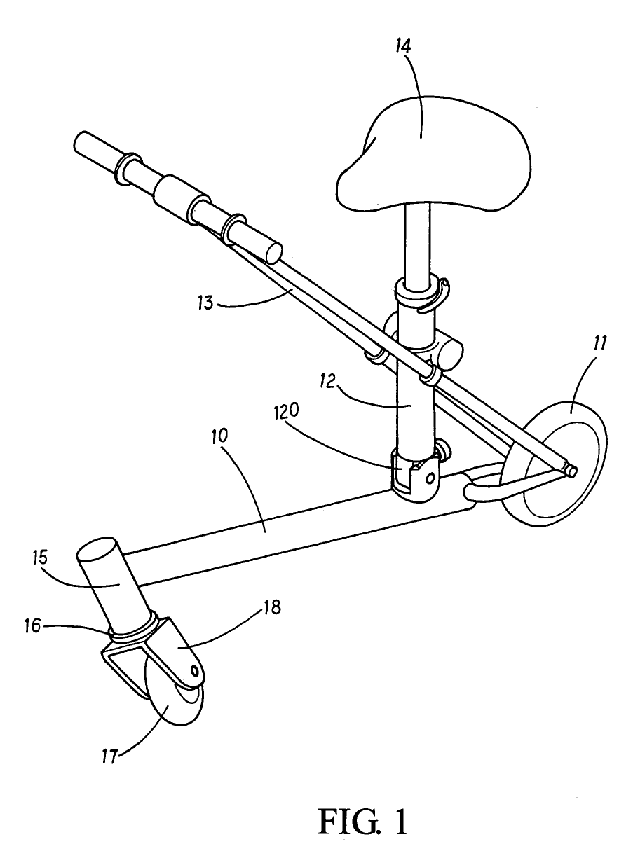

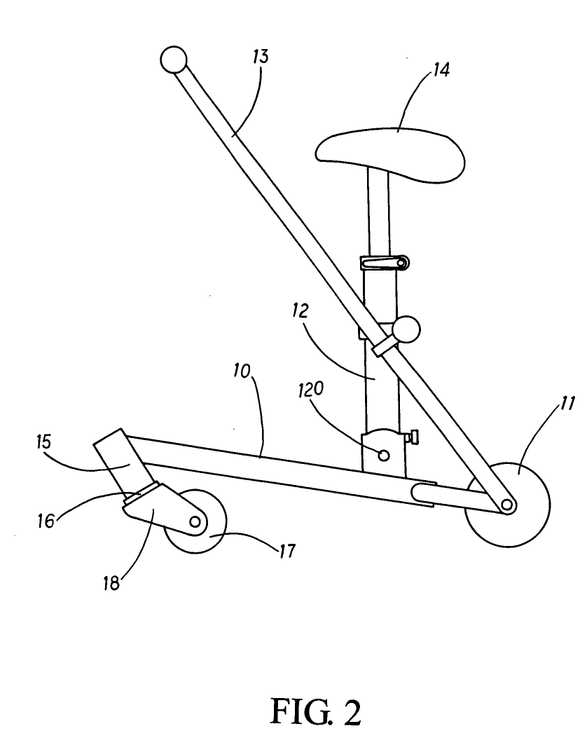

Referring to FIG. 1 to 3, a preferred embodiment according to the present invention comprises a main frame 10, a rear wheel 11 pivotally mounted on the rear end of the main frame 10, a seat post 12 erected on the top surface of the main frame 10 and a handle frame 13 extending obliquely upwardly from the rear end of the main frame 10 toward the front portion of the cart. The seat post 12 is anchored in a folding unit 120 attached on the main frame 10, by which the seat post 12 can collapse toward the main frame 10. The seat 14 is mounted on the top end of the seat post 12. The front end of the main frame 10 is provided with a brace 15 having a turntable 16 attached thereunder. A wheel holder 18 extends obliquely from the bottom surface of the turntable 16, for retaining a front wheel 17.

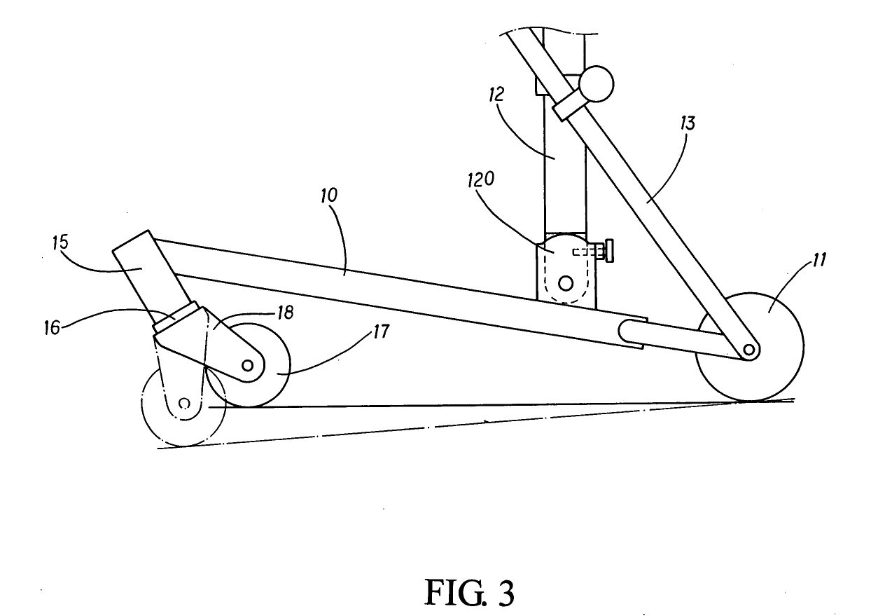

To ride the walk-assisting cart, a rider firstly adjusts the seat 14 to a suitable height for sitting, and then straddles across the main frame 10. The hands of the rider are put on the handle frame 13 for controlling the moving direction. The main frame 10 supports the weight of the rider, and the rider at the same time executes normal foot stepping about the main frame 10 to drive the cart forward. To maintain a steady straight motion and a stable mechanism of changing direction, the front wheel under the turntable 16 situates off the axis of the brace 15, thereby the front wheel 17 is pivotally movable about the center of the turntable 16. The axis of the turntable 16 is tilted toward the axis of the main frame 10. Therefore, if the front wheel 17 is not restricted by the gravity of the main frame 10, the front wheel 17 can perform off-center rotation about the axis of the turntable 16. As shown in FIG. 3, the front wheel 17 thus has a nearest and a farthest points related to the main frame 10. As the rider rides the cart forward on a flat ground, the frictional force and stress produced during the rolling of the front wheel 17 on the ground urge the front wheel 17 so that it is at the nearest point. Since the front wheel 17 supports the weight of the rider, the wheel holder 18 for the front wheel 17 therefore cannot erect upward freely and the front wheel 17 cannot change direction easily. More specifically, since the front wheel 17 is at the nearest point, any change in direction requires an upward motion of the wheel holder 18, and therefore a rotational torque is needed to overcome the downward pressure on the front wheel 17 due to the weight of the rider and the cart itself. Therefore, the front wheel 17 and the main frame 10 maintain an equilibrium configuration by which the cart can go straight naturally.

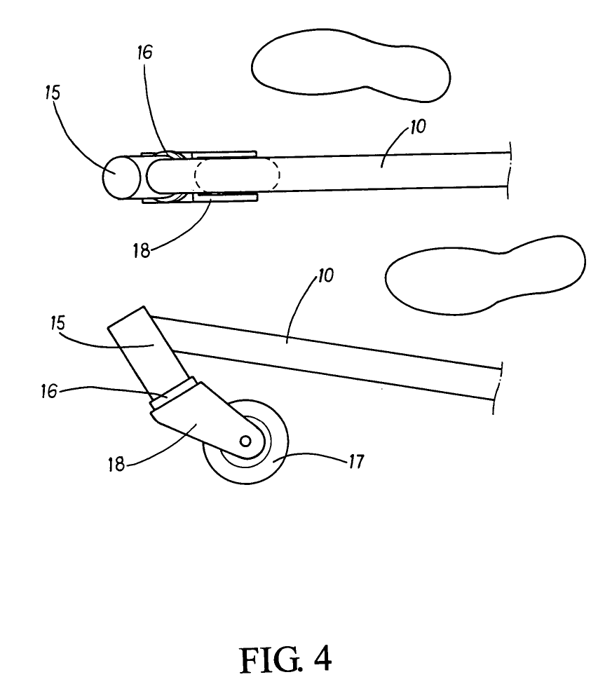

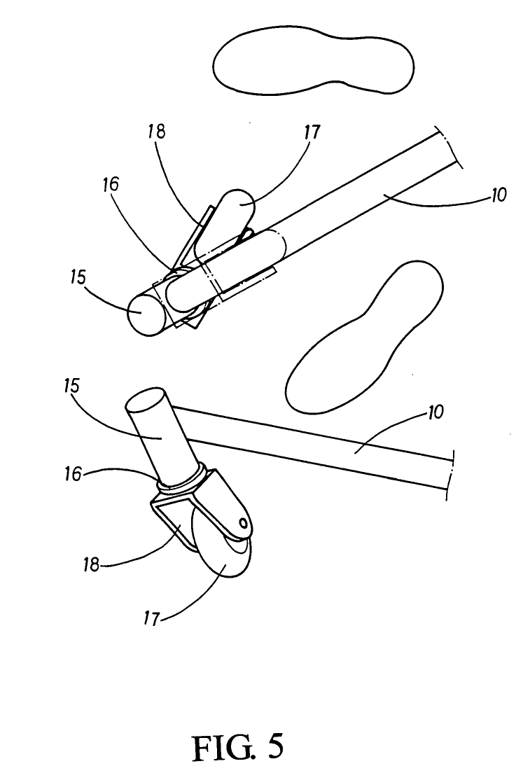

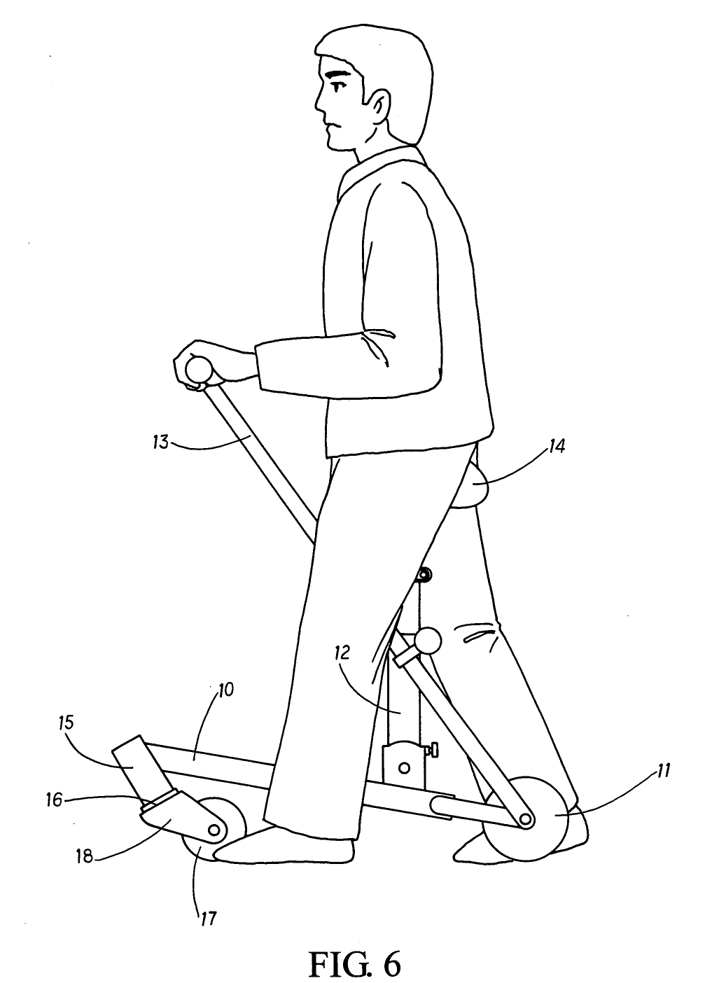

Referring to FIGS. 4 and 5, to turn the cart to another direction, the foot of the rider corresponding to the direction turning to steps outward, thereby the main frame 10 tilts toward the direction. Since the front wheel 17 is off the axis of the turntable 16, it acquires a torque opposite to the turning direction, thereby the front wheel 17 moving off the nearest point and being driven upward; this upward force provides a centripetal component necessary for a turning motion. Referring to FIGS. 5 and 6, as the cart moves straight again, the front wheel 17 is again pressed downward, and the frictional force and stress guide the front wheel 17 back to the nearest point. The above features in structure of the present invention enable stable straight motion of the walk-assisting cart, achieving the purposes of convenience and safety.

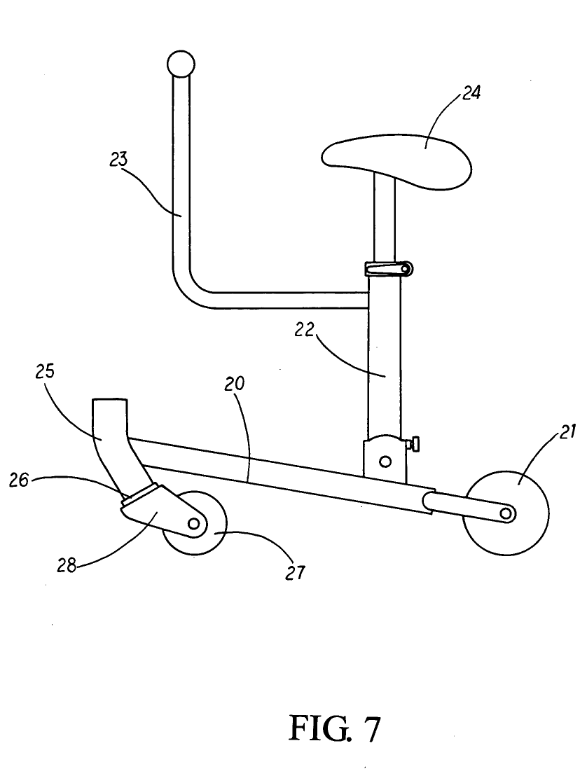

Referring to FIG. 7, the second preferred embodiment of the present invention comprises a main frame 20 pivotally provided with a rear wheel 21 at the end thereof. A seat post 22 erects from the top lateral surface of the main frame 20. A handle frame 23 extends from two lateral sides of the seat post 22. A seat 24 is mounted on the top end of the seat post 22. The front end of the main frame 20 is provided with a brace 15, whose axis is bent toward the rear end of the main frame 20. The bottom end of the brace 25 is provided with a turntable 26 and a wheel holder 28 is extended under the turntable 26 to retain a front wheel 27. The front wheel 17 situates off the axis of the turntable 26 and extends in the opposite direction of the axis of the main frame 20. In the configuration of this preferred embodiment, the handle frame 23 is more simply connected to the seat post 22, and the attachment of the brace 25 to the main frame 20 is enhanced.

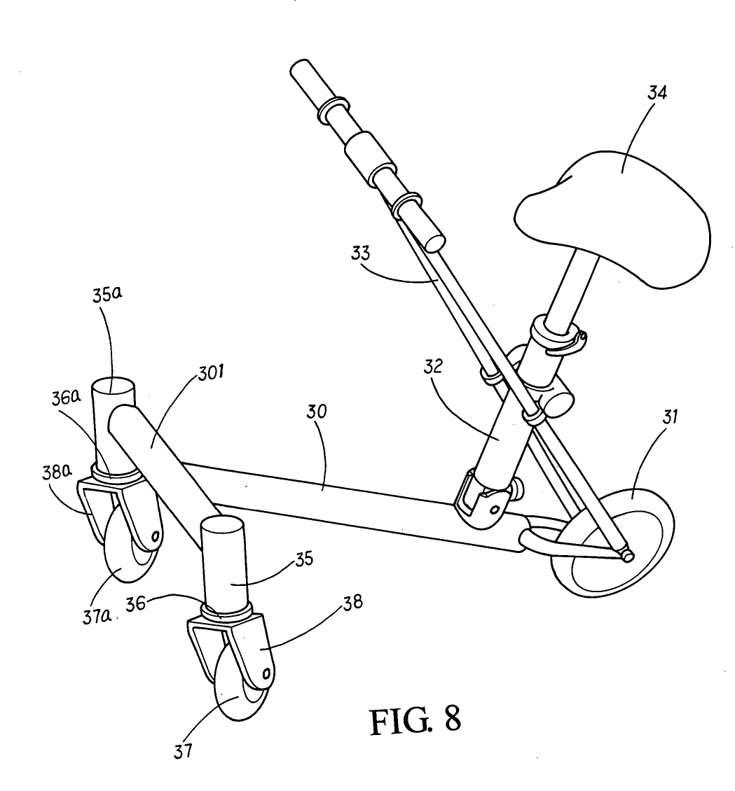

Referring to FIG. 8, the third preferred embodiment of the present invention comprises a main frame 30 having a rear wheel 31 pivotally connected to the rear end of the main frame 30. The top lateral surface of the main frame 30 is connected to a seat post 32, a handle frame 33 and a seat 34. A connecting bar 301 having two braces 35 and 35a each at one end thereof is connected to the front end of the main frame 30. Two braces 35 and 35a are respectively provided with a turntable (36, 36a), a wheel holder (38, 38a) and a front wheel (37, 37a). Both the wheel holders 38, 38a are tilted toward the read end of the main frame 30. The walk-assisting cart thus formed is of three-wheel structure. To operate the cart, a rider straddles on the main frame 30 and drives the cart forward by normal foot steeping. The main frame 30 supports the weight of the rider, and the rider's gravity therefore presses the front wheel 37, 37a downward through the connecting bar 301, achieving steady forward movement. This preferred embodiment further enhances the convenience and safety of the present invention.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

1. A walk-assisting cart, comprising:
a main frame being a tough tubular body;
a rear wheel pivotally connected to a rear end of said main frame;
a seat post extended uprightly from a lateral surface of said main frame;
a seat mounted at a top end of said seat post;
a handle frame extended from said main frame, the handle grip portion of said handle frame situating in front of said seat post;
a brace mounted at a front end of said main frame;
a turntable rotatably mounted under a lower end of said brace,
a wheel holder obliquely extended from a bottom face of said turntable; and
a front wheel retained by said wheel holder, said front wheel situating off the axis of said turntable;
whereby said wheel holder retaining said front wheel tends to tilt toward said rear end of said main frame when said front wheel is weighed upon.

2. The walk-assisting cart of claim 1 wherein a folding unit mounted on said main frame connecting said seat post, thereby said seat post being capable of collapsing toward said main frame.

3. The walk-assisting cart of claim 1 wherein said handle frame has a bottom end connected to said rear end of said main frame and tilts toward said front end of said main frame, and wherein said handle frame is further secured onto said seat post, thereby said grip portion of said handle frame being in a suitable position for placing hands.

4. The walk-assisting cart of claim 2 wherein said handle frame has a bottom end connected to said rear end of said main frame and tilts toward said front end of said main frame, and wherein said handle frame is further secured onto said seat post, thereby said grip portion of said handle frame being in a suitable position for placing hands, and wherein said handle frame and said seat post can be disengaged so that said handle frame and said seat post can both collapse onto said main frame.

5. The walk-assisting cart of claim 1 wherein said handle frame is extended from a lateral wall of said seat post, firstly horizontally and then vertically.

6. The walk-assisting cart of claim 2 wherein said handle frame is extended from a lateral wall of said seat post, firstly horizontally and then vertically.

7. A walk-assisting cart, comprising:
a main frame being a tough tubular body;
a rear wheel pivotally connected to a rear end of said main frame;
a seat post extended uprightly from a lateral surface of said main frame;
a seat mounted at a top end of said seat post;
a handle frame extended from said main frame, the handle grip portion of said handle frame situating in front of said seat post;
a connecting bar having a center thereof mounted at a front end of said main frame, said connecting bar being perpendicular to the axis of said main frame;
a pair of braces each mounted at one end of said connecting bar;
a pair of turntables respectively rotatably mounted under said braces,
a pair of wheel holders respectively extended from bottom faces of said turntables with a tilt angle with respect to the axes of said turntables; and
a pair of front wheels respectively retained by said wheel holders, said front wheels situating off said axes of said turntables;
whereby said wheel holders retaining said front wheels tends to tilt toward said rear end of said main frame when said front wheels are weighed upon.
